(19) United States
(12) Patent Application Publication
(10) Pub. No.: US 2021/0176927 A1
(43) Pub. Date: Jun. 17, 2021

(54) STUMP GRINDER CHIP CHUTE DEVICE AND SYSTEM

(71) Applicant: Leonardi Manufacturing Co., Inc., Weedsport, NY (US)

(72) Inventor: Joseph A. Leonardi, Auburn, NY (US)

(73) Assignee: Leonardi Manufacturing Co., Inc., Weedsport, NY (US)

(21) Appl. No.: 16/760,802

(22) PCT Filed: Oct. 31, 2018
(86) PCT No.: PCT/US2018/058393

§ 371 Date: Apr. 30, 2020

Related U.S. Application Data
(60) Provisional application No. 62/579,662, filed on Oct. 31, 2017.

(51) Int. Cl. A01G 23/06; B02C 18/22; B65G 11/12

(52) U.S. Cl. CPC A01G 23/067; B65G 11/126; B02C 18/2216

(57) ABSTRACT

A chip chute system structured and/or configured to capture chips cut from a stump by a stump grinding/cutting wheel, harness the energy in the cut chip imparted by the stump grinding wheel, and control/direct the cut chips to a desired chip collection location such as a bin or other collection receptacle.

### CROSS-REFERENCE TO RELATED APPLICATION

This application claims priority to U.S. Provisional Patent Application Ser. No. 62/579662, filed on Oct. 31, 2017 and entitled “Stump Grinder Chip Chute Device and System.”

### FIELD OF THE INVENTION

The present disclosure relates generally to stump grinders/cutters. More particularly, the present disclosure relates to stump grinder chip chute devices and systems for capturing chips cut from a stump by a stump grinding/cutting wheel, harnessing the energy in the cut chip imparted by the stump grinding wheel, and controlling/directing the cut chips to a desired chip collection location.

### BACKGROUND

Various conventional stump grinders with chip guard devices/systems exist. For example, the Carlton SP5014 TRX Series Track-Mounted Stump Cutter includes a chip guard. However, the chip guard of this stump cutter is only configured to partially contain the cut chips and stones in the working/cutting area and prevent the cut chips from spreading too far from the cut area, and end up recutting and regrinding the chips. The chips cut by this stump cutter (and all other conventional stump cutters with chip guard devices/systems) cannot be captured and controlled/directed to a desired chip collection location.

Accordingly, the inventor recognized that there is a need in the art for improved stump grinder chip chute devices and systems for capturing chips cut from a stump by a stump grinding/cutting wheel and controlling/directing the cut chips to a desired chip collection location.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety(ies).

### SUMMARY OF THE INVENTION

The present disclosure is directed to inventive devices and systems structured and/or configured to work with and harness the energy in chips cut from a stump by a stump grinding/cutting wheel. A particular non-limiting goal of the utilization of the embodiments and implementations herein is to provide a device and system which is structured and/or configured to capture chips cut from a stump by a stump grinding/cutting wheel, harnessing the energy in the cut chip imparted by the stump grinding wheel, and control/direct the cut chips to a desired chip collection location such as a bin or other collection receptacle.

It is a primary object and advantage of an embodiment of the present invention to contain the cut chips by creating a sufficient seal on the proximal end of the chip chute system, and controlling and directing the chips to a particular collection bin or target location on the distal/discharge end of the chip chute system. The better the seal and control/direction of the cut chips, the less time a user needs to spend on cleaning up scattered chips not positioned in a collection bin location (compare to the conventional chip guard systems, where the chips are scattered and need to be cleaned/picked up and moved to a collection location after a stump is cut/ground). In addition to minimizing clean up time, the chip chute system of an embodiment helps maintain a clear view of the stump being cut, and can better protect the stump cutting wheel by allowing a user to avoid rocks and other hard material in the ground near the stump being cut (as opposed to conventional chip guard systems that spray cut chips right in the work area masking any such damaging material).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The details of one or more embodiments are described below and in the accompanying drawings. Other objects and advantages of the present invention will be apparent from and elucidated with reference to the embodiment(s) described hereinafter.

### BRIEF DESCRIPTION OF THE DRAWINGS

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIGS. 1A-F are various schematic representation views of a stump grinding wheel with a chip chute system according to an embodiment.

FIG. 2 is a digital photograph of the stump grinding wheel with the chip chute system of FIGS. 1A-F attached to and being maneuvered by a movable machine according to an embodiment.

FIGS. 3A-D are side schematic representation views of the stump grinding wheel with the chip chute system of FIGS. 1A-F according to an embodiment.

FIGS. 4A-C are various schematic representation views of the stump grinding wheel used in conjunction with the chip chute system of FIGS. 1A-F according to an embodiment.

FIGS. 5A-B are various schematic representation views of the stump grinding wheel with the chip chute system of FIGS. 1A-F according to an embodiment.

FIG. 6A is a side schematic representation view of a stump grinding wheel with a chip chute system, and FIG. 6B is an exploded section view of sectioned portion “C” of FIG. 6A, according to an embodiment.

FIGS. 7A-C are various schematic representation views of a stump grinding wheel with a chip chute system according to an alternative embodiment.

FIG. 8 is a side schematic representation view of a stump grinding wheel with a chip chute system according to an alternative embodiment.

FIG. 9 is a side schematic representation view of a stump grinding wheel with a chip chute system according to an alternative embodiment.

FIG. 10 is a side schematic representation view of a stump grinding wheel with a chip chute system according to an alternative embodiment.

FIG. 11 is a side schematic representation view of a stump grinding wheel with a chip chute system according to an alternative embodiment.

FIG. 12 is a side schematic representation view of a stump grinding wheel with a chip chute system according to an alternative embodiment.

Where applicable, like reference characters designate identical or corresponding components and units throughout the several views, which are not to scale unless otherwise indicated. Moreover, the embodiments disclosed herein may include elements that appear in one or more of the several views or in combinations of the several views.

### DETAILED DESCRIPTION OF EMBODIMENTS

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

As further background information helpful to understanding this detailed description, the cut material (including cut stump chips) in stump grinding starts out more wood then soil depending on how high off the ground the stump is. As stump grinding moves below ground level, the cut material becomes more soil than wood. The “chip” or cut material will vary with the type and age of the tree (i.e., dry and crumbly to wet, sappy & sticky). The soil can range from desert dry and dust-like to wet, sticky clay. The shape of the wood chip portion of the cut material can be chunks a quarter of the size of a postage stamp. The wood chip could also be a foot long and 2 inches wide depending on the type of cutting tooth, machine Horsepower, moisture level and type of tree. The cut material will typically travel in a straight line as it leaves the cut. The “chip” or cut material can act like a feather or to the other extreme like a rock (and can be a rock) or a baseball or an even worse combination like sticky gum. The cut material can be a combination of soil and wood. Depending on this combination of variables and the speed of the wheel, the “chip” will travel a short distance of a few inches to as much as a few hundred feet. The “chip” or cut material will travel in continued motion if a “seal” is maintained; if the seal is interrupted then re-established the “chip” can be picked up by the spinning wheel and moved again or put back into motion (as described further herein).

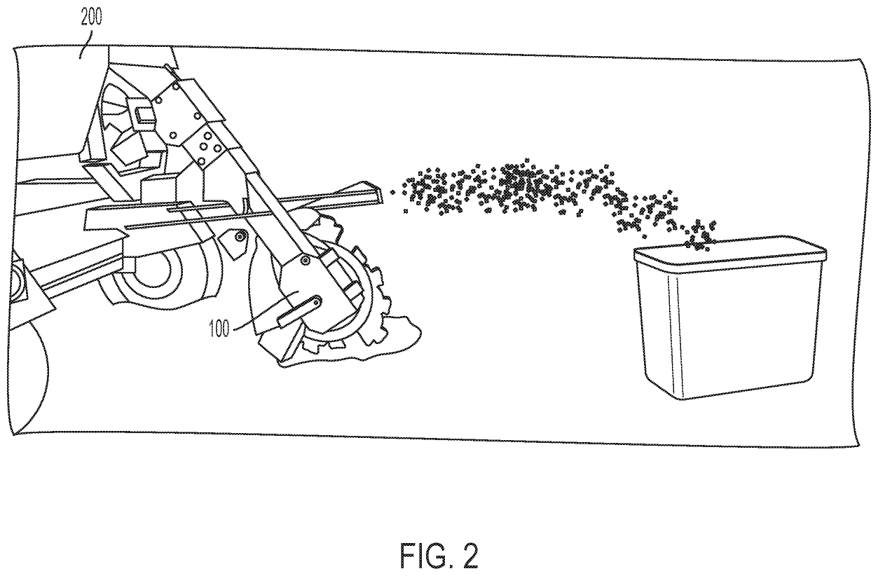

As should be understood with a review of this disclosure and the accompanying drawings, a chip chute system of an embodiment of the present invention has a collection or proximal/first end (end positioned closest to the ground when in use) that is structured and configured to collect chips cut by a stump grinding wheel and to harness the energy of the cut chips exiting the wheel at an initial wheel exit point. The proximal end of the chip chute system is structured and configured to harness the energy of the cut chips, in part, by creating at least a partial “seal” at the (or close to) the initial wheel exit point (which can be at least 50% and preferably above 70% of the cut chips, as should be understood by a person of ordinary skill in the art in conjunction with a review of this disclosure), funnel the cut chips (which can be at least 50% and preferably above 70% of the cut chips) back toward the stump cutting tooth assemblies positioned on the stump grinding wheel, trap the chips against or close to the wheel, and direct the cut chips to the next portion within the chip chute system and eventually to the exit point and out of the chip chute system. The chip chute system of an embodiment of the present invention can also have a second or middle portion and a distal/third or exit end (end opposite the proximal/first end). Each of the second and third ends can be (but don't have to be) structured and configured to be adjustable to aim chips cut by the stump grinding wheel at a particular targeted location for collection (e.g., a bin positioned in front of, behind, above or to either side of the stump grinding wheel with a chip chute system—see, e.g., FIG. 2).

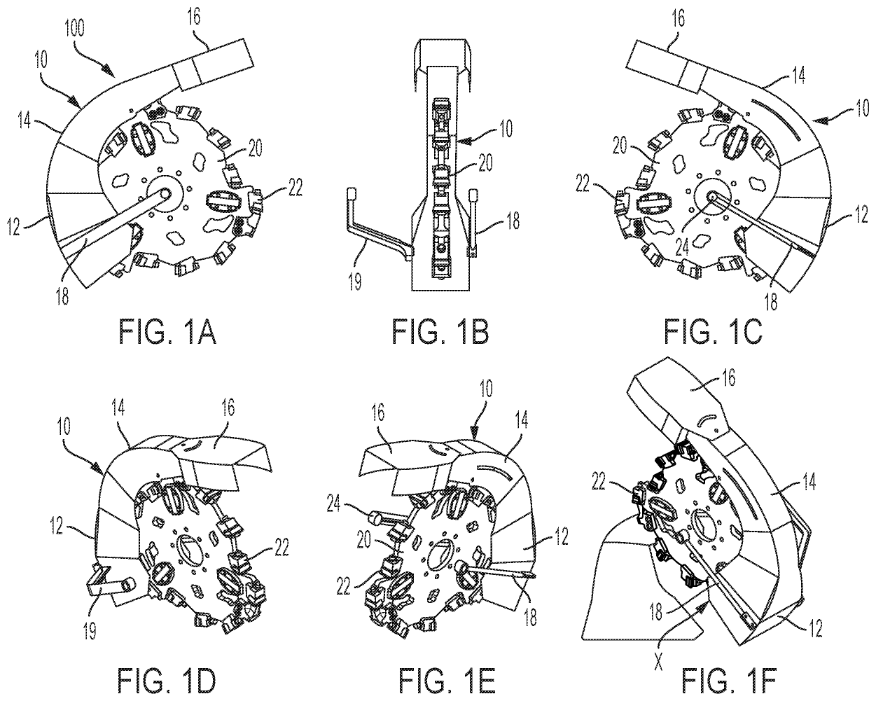

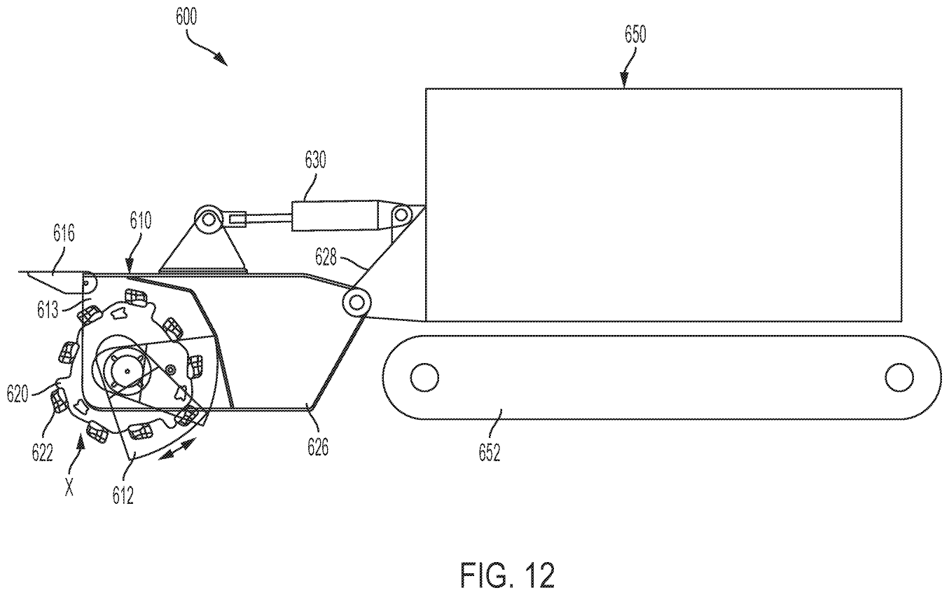

Turning to FIGS. 1A-F, various schematic representation views of a stump grinding wheel with a chip chute system 100 are shown according to an embodiment. In particular, a stump cutting/grinding wheel 20 is shown with a central longitudinal axis 24 and stump cutting tooth assemblies 22 (which can include any stump cutting/grinding wheel with stump cutting tooth assemblies, as should be understood by those of skill in the art, including, for example, the stump cutting tooth assembly and stump cutting wheel shown and described in U.S. Pat. No. 8,584,717) attached to the perimeter and/or to the sides thereof. The “footprint” of at least some of the cutting bits of the stump cutting tooth assemblies 22 can be at least partially shielded by a “footprint” of the perimeter 700 of the stump grinding wheel 20, or a “footprint” of a specific shield assembly 710 placed in “front” (as determined by the direction of the spin of the wheel) of the stump cutting tooth assemblies 22 on the perimeter (extending a particular radial/axial distance from a surface of the wheel or as compared to other surfaces of the wheel) of the wheel or on the side 720 (extending a particular axial distance from the side of the wheel) of the wheel (depending on whether the stump cutting tooth assemblies 22 are placed on the side of the wheel or on the perimeter of the wheel), as should be understood by a person of ordinary skill in the art in conjunction with a review of this disclosure. A chip chute system 10 is shown positioned partially around the stump cutting wheel 22, and the chip chute system 10 is connected to the stump cutting wheel 20 via at least one bar 18 and/or 19 or the frame of a “stand behind” or other machine that can maneuver the stump grinding wheel with the chip chute system 100, as should be understood by a person of skill in the art in conjunction with a review of this disclosure (see FIG. 2, showing the stump grinding wheel with the chip chute system 100 attached and being maneuvered by a movable machine 200). The other bar can attached to an arm or other portion of a “stand behind” or other machine that can maneuver the stump grinding wheel with the chip chute system 100. The frame of a “stand behind” or other machine that can maneuver the stump grinding wheel with the chip chute system 100 can also be structured and configured to include part of the chip chute system, as described herein (see FIG. 12 and related description below).

Referring still to FIGS. 1A-F, the chip chute system 10 can include (but is not limited to) a first or proximal portion 12 (closest to the ground during use), a second or middle portion 14, and a third or distal/exit portion 16. The second 14 and third 16 portions can be one single portion (or there can be just one proximal portion and one distal portion with no middle portion). This first portion 12 is structured and configured to collect chips cut by the stump grinding wheel 20 and to harness the energy of the cut chips exiting the wheel 20 at an initial wheel exit point “X” (see FIG. 1F, where the wheel is spinning counterclockwise and cutting a stump “S”). The chip chute system 10 is structured and configured to harness the energy of the cut chips, in part, by creating at least a partial “seal” at the (or close to) the initial wheel exit point “X” (as should be understood by a person of ordinary skill in the art in conjunction with a review of this disclosure), funneling the cut chips back toward the stump cutting tooth assemblies 22 positioned on the stump grinding wheel 20, trapping the chips against or close to the wheel 20 or in the air stream generated by the spinning wheel 20, until the chips exit the distal end of the third portion 16 of the chip chute system 10. The most proximal portion of the first end 12 can have an opening with an area that is larger than another portion of the chip chute system positioned distally of the first end 12 to enable collection of more chips and the creation of a better seal (i.e., can be funnel shaped). The most proximal portion can be angled close to the cut, and even be positioned in a plane that is perpendicular to the travel of the chip post-cut. Further, the distance between where the chip exits the cut and enters the first end 12 can be from 0 inches to 5 inches, and preferably 0 inches to 3 inches. The bigger the wheel 20, the larger acceptable distance to maintain the seal. The most proximal seal portion can also be a combination of flexible and fixed material (e.g., metal and rubber). The chip chute system 10 may have a manual override mechanism to break the seal and allow material to pass by lifting proximal end 12 away from the location where the chip exits the cut (mechanical, e.g., via wires mechanical linkage, ball joints, hydraulic/pneumatic cylinders, servos, electro-magnetic, and/or electronically controlled, as should be understood by a person of skill in the art in conjunction with a review of this disclosure). As shown, the chip chute system 10 is preferably three sided and open toward the wheel as opposed to being fully enclosed (e.g., a pipe), although it can have a bottom and be shaped like a pipe. The three-sided embodiment allows for natural cleaning of the inside of the chip chute system 10 by the wheel 20 with the assistance of gravity.

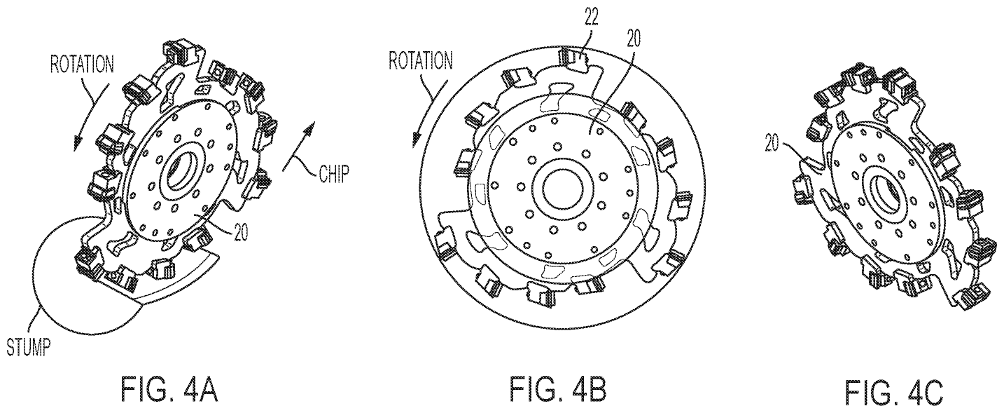

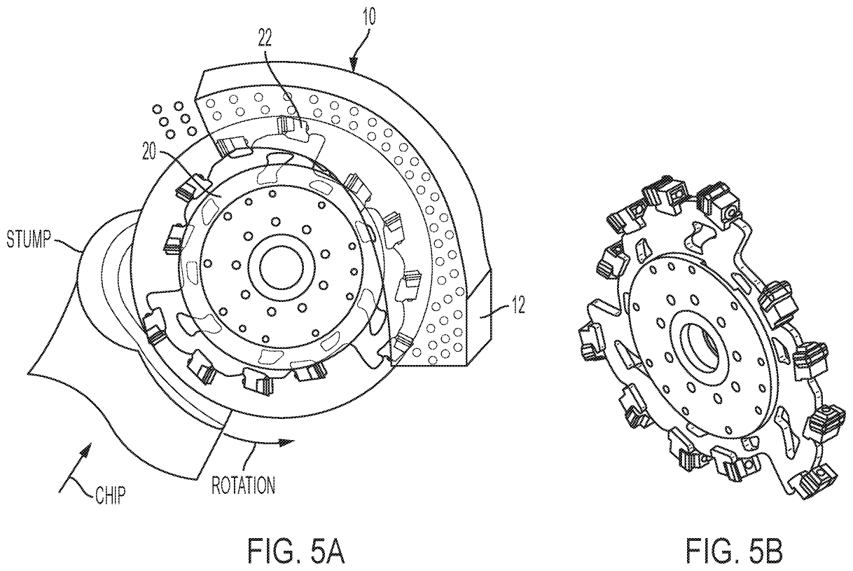

The first portion 12 can (but does not have to) move or telescope within middle portion 14 (or vice versa) in order to allow the first portion to easily follow the contour of the ground without breaking. Each bar 18 and 19 can pivot at the central axis point 24, and move up and down with the first portion 12. This structural configuration assists with the maintenance of the seal, described above. Moreover, the chip chute system 10 can be contoured and positioned tight around the stump grinding wheel (preferably where at least one cutting tooth is immediately adjacent to the internal surface of the chip chute system 10, or within a tooth length of the internal surface (see FIG. 4C for an example tooth length), or touching the internal surface, or at least touching or immediately adjacent to a boundary layer 30 of packed chips and soil, clay (earth) etc. formed on the internal surface of the chip chute system 10 (see, e.g., FIG. 5), where the cutting teeth impart energy to the chips so that the chips can harness and maintain energy received from the wheel 20 through the trip through the chip chute system 10, or form a fairly smooth channel through the boundary layer 30 for cut chips to move through and out from with minimally reduced energy and speed that has been imparted in the chips). If there is a boundary layer, the internal surface of the chip chute system 10 can be positioned further away from the perimeter of the wheel 20 or closest stump cutting tooth assembly positioned on the perimeter of the wheel 20. This structural configuration keeps the chip close to the stump grinding wheel 20 and assists with the harnessing/maintaining of the energy of the chip received from the stump grinding wheel 20, described above. A boundary layer will be less likely to form if the chip chute system 10 is further away from the wheel, and/or if the cut chips are very dry.

In addition, a portion of the chip chute system 10 or the chip chute system 10 as a whole can include an articulation/steering control assembly (mechanical, e.g., via wires mechanical linkage, ball joints, hydraulic/pneumatic cylinders, servos, electro-magnetic, and/or electronically controlled, as should be understood by a person of skill in the art in conjunction with a review of this disclosure). For example, the middle portion 14 can move left and/or right and up and/or down via a hinged or other like connection (e.g., radial adjustment, pivoting) to first portion 12. Alternatively or additionally, third portion 16 can move left and/or right and up and/or down via a hinged or other like connection (e.g., radial adjustment, pivoting) to middle portion 14. This steering control assembly is thus structured and configured to be adjustable to aim chips cut by the stump grinding wheel at a particular targeted location for collection (e.g., a bin positioned in front of (see, e.g., FIG. 2), behind, above or to the side of the stump grinding wheel with a chip chute system). Alternatively, the chip chute system can be made of one fixed or multiple fixed parts, and include a flap at the proximal, middle and/or distal ends to control and direct the flow and discharge of the chips. The chip chute system can include a smooth internal surface that can also be lubricated with any known lubricant (as should be understood by a person of ordinary skill in the art in conjunction with a review of this disclosure).

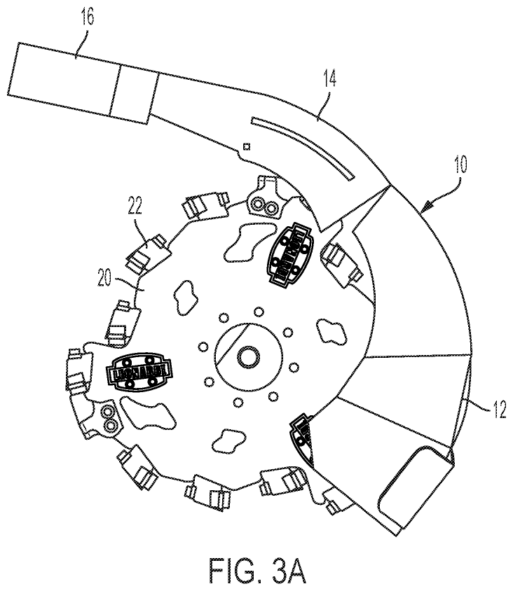

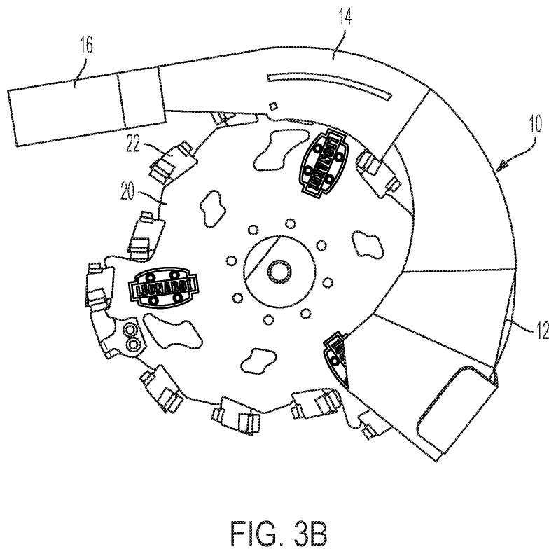

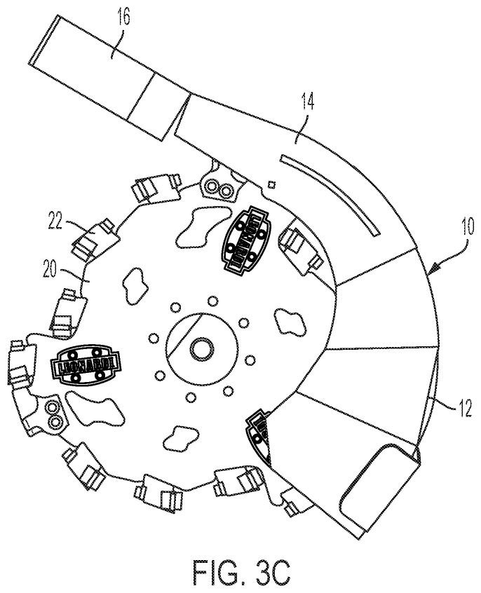

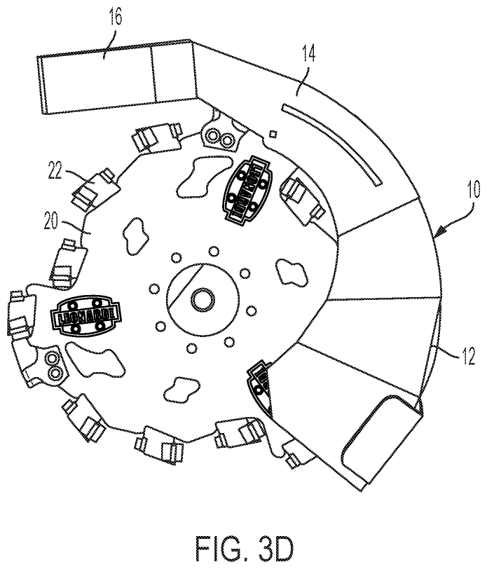

Turning to FIGS. 3A-B, in one embodiment, side schematic representation views of the stump grinding wheel with a chip chute system 100 are shown. FIG. 3A shows the second 14 and third 16 portions pivoted up at the position between the first 12 and the second portions 14. FIG. 3B shows the second 14 and third 16 portions pivoted back down at the position between the first 12 and the second portions 14.

Turning to FIGS. 3C-D, in one embodiment, side schematic representation views of the stump grinding wheel with a chip chute system 100 are shown. FIG. 3A shows the third 16 portion pivoted up at the position between the third 16 and the second portions 14. FIG. 3B shows the third 16 portion pivoted back down at the position between the third 16 and the second portions 14.

Referring to FIGS. 4A-C, in one embodiment, various schematic representation views of a stump grinding wheel 20 without the chip chute system are shown. FIG. 4A shows a perspective schematic representation view of the stump grinding wheel 20 rotating in the clockwise direction against a stump “S”. FIG. 4B shows a side schematic representation view of the stump grinding wheel 20 rotating in the clockwise direction, and the ground, the normal stump cutting quadrant of the stump grinding wheel 20 (which can be more than one quadrant as should be understood by those of skill in the art in conjunction with a review of this disclosure), the normal chip direction, the x, y, and z axes, the wheel radius length, and the ¼, ½, and ¾ wheel radius length down from the midway point plane “M” of the wheel. FIG. 4C shows a perspective schematic representation view of the stump grinding wheel 20 with a tooth width and tooth length measurements. This is a configuration where the chip chute system 10 can be the narrowest. The cut width can be different if the teeth are positioned on the side of the wheel 20, and not (or in addition to) the perimeter, and the chip chute system width would necessarily need to be wider to accommodate the difference in total tooth width.

Referring to FIGS. 5A-B, in one embodiment, various schematic representation views of a stump grinding wheel with a chip chute system 100 are shown. FIG. 5A shows a side schematic representation view of the stump grinding wheel 20 rotating in the clockwise direction against a stump “S” along with the cut direction, and with the chip chute system 10 presented in a transparent view over the wheel 20. The transparent chip chute system 10 allows viewing of the stump cutting tooth assemblies 22 positioned, and the chips entering and the boundary layer 30 formed, within the chip chute system 10. As discussed above, a nice and tight boundary layer allows the wheel 20 to form a channel with the boundary layer surrounding the channel very close to or touching the wheel, or highest positioned tooth on the perimeter of the wheel, to maintain the energy in the chip through the chip chute system 10 based on (or obtained from) the spinning wheel. Also, as shown, the proximal end of the first portion 12 of the chip chute system 10 is positioned at ¾ wheel radius below the midpoint plane of the stump grinding wheel 20. This allows for the generation of the seal, discussed above, while at the same time provides some clearance for an uneven ground. FIG. 5B shows a perspective schematic representation view of the stump grinding wheel 20. A cutting width and a cutting length are also shown. The furthest away from the wheel the chip chute system 10 can be as still work effectively is a function the creation and maintenance of the energy imparted to the chip by the wheel (the closer the chip is kept to the wheel by the chip chute system 10, the better maintenance and control of the energy imparted to the chip), and can also be based on the creation of a sufficient boundary layer (the closer the distance between the boundary layer and the perimeter of the wheel 20 or tooth assemblies 22, the more likely the created channel will be tight on the wheel, as discussed above).

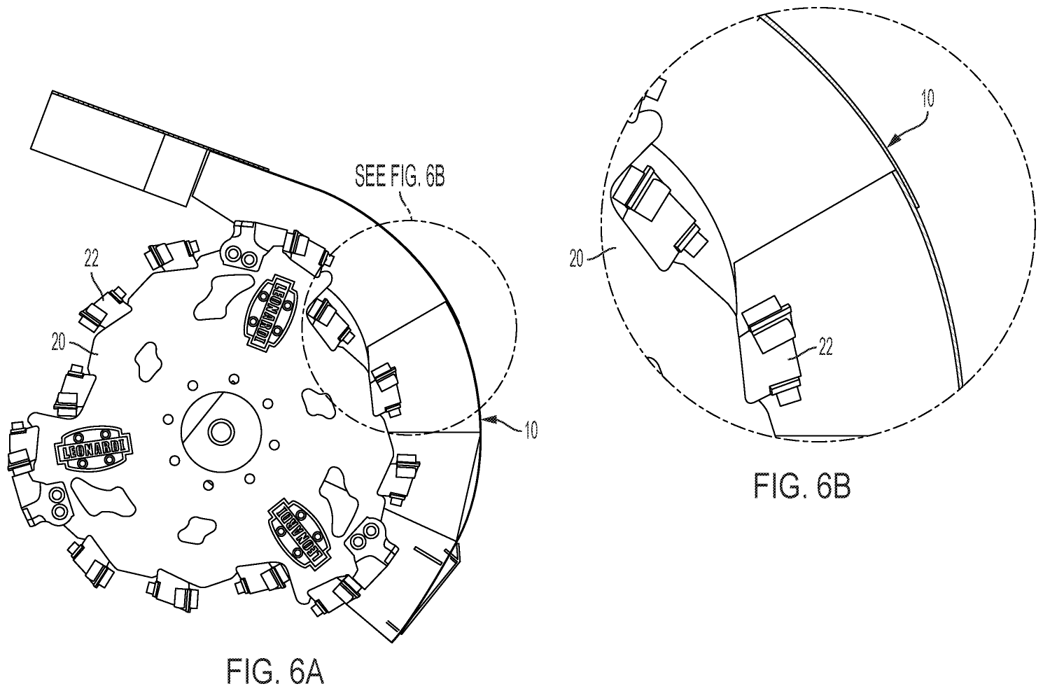

Turning to FIG. 6A, a side schematic representation view of a stump grinding wheel with a chip chute system 100 is shown. FIG. 6B shows an exploded section view of sectioned portion “C” of FIG. 6A. These figures show a transparent chip chute system 10 positioned over the stump grinding wheel 20, where the stump cutting tooth assemblies 22 can be seen positioned within the chip chute system 10.

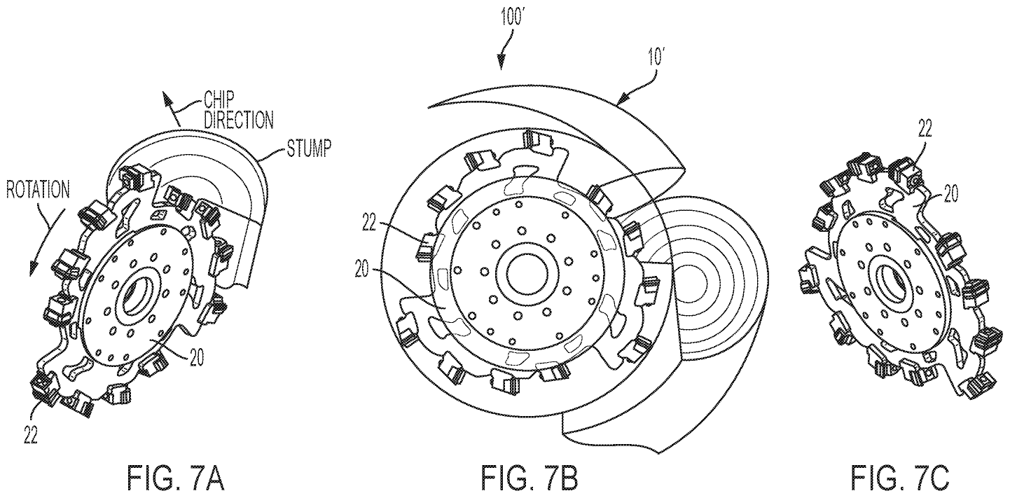

Referring to FIGS. 7A-C, in an alternative embodiment, various schematic representation views of a stump grinding wheel with a chip chute system 100′ are shown. FIGS. 7A and 7B show the stump grinding wheel rotating against a stump “S” in a counterclockwise direction. FIG. 7B shows a chip chute system 10′ positioned partially around the stump grinding wheel 20 and pointing at a target in the opposite direction as compared to the previous figures. FIG. 7C is another perspective view of the stump grinding wheel 20.

Additional alternative embodiments of the stump grinding wheel with a chip chute system as discussed below. These embodiments contain different structural configurations, together with some of the same structural configurations as discussed above. All of the structure and/or functionality discussed above with respect to the formation of the seal, adjustability of the chip chute system, and other unique configurations, apply equally to the embodiments discussed below (and vice versa).

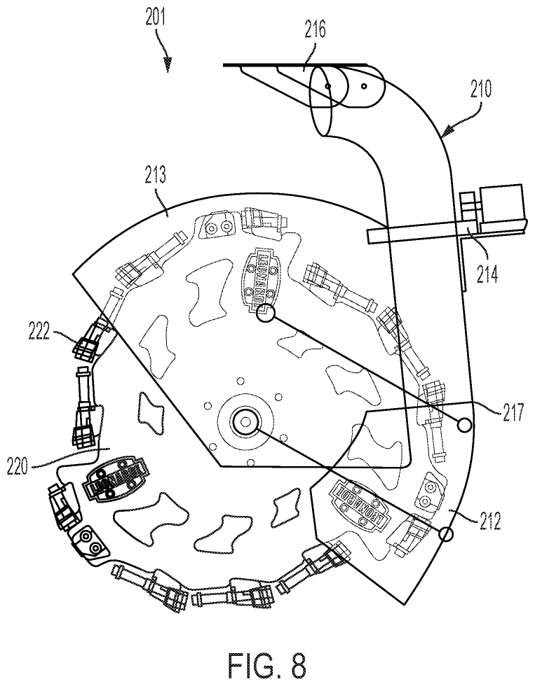

Turning to FIG. 8, a side schematic representation view of an alternative embodiment of the stump grinding wheel with a chip chute system 201 is shown. A stump grinding wheel 220 with stump cutting tooth assemblies 222 are shown with a guard device 213 (shown in a transparent view) positioned at least partially around the wheel, at least on a side that is opposite the wheel's cutting section. Positioned adjacent and proximally to the wheel 222 and guard section 213 is the chip chute system 210 (shown in a transparent view, and which can also be attached directly to the wheel 222 at or near the central axis or indirectly to the wheel by being attached to the guard section 213, which can be attached to the wheel at or near the central axis, or other location as should be understood by a person of skill in the art in conjunction with a review of this disclosure). This chip chute system 210 is open to capture cute chips at its proximal end 212, and is configured to form a seal etc. (as discussed with respect to other embodiments above), and is enclosed (e.g., tubular-shaped, pipe-shaped) above the proximal end between position 217 and the distal end 216. The distal end is open at its most distal end for chips to exit. This embodiment of the chip chute system 210 can be adjustable at jointed or other sections like previously discussed embodiments, including at the flap or rotatable damper elements shown at the distal end 216 of the chip chute system 210. Further, the chip chute system 210 can be connected to the frame of a “stand behind” or other machine at 214 that can maneuver the stump grinding wheel with the chip chute system 201, as should be understood by a person of skill in the art in conjunction with a review of this disclosure.

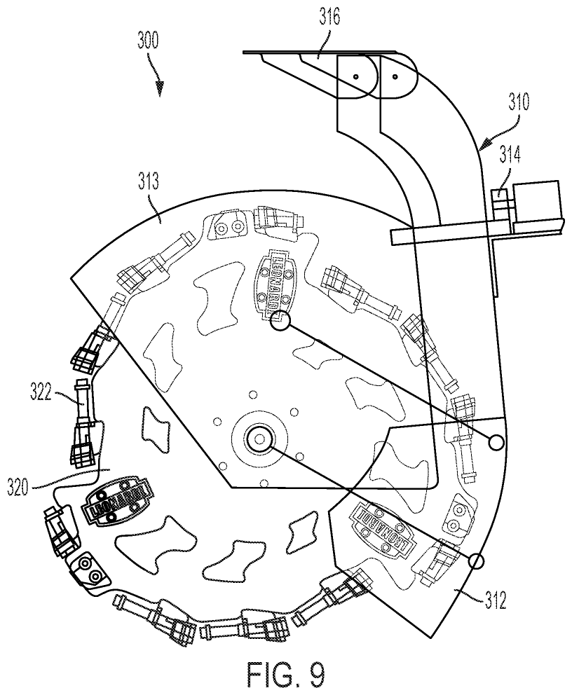

Referring to FIG. 9, a side schematic representation view of an alternative embodiment of the stump grinding wheel with a chip chute system 300 is shown. This embodiment is very similar to the embodiment shown and described with respect to FIG. 8. The only difference is the chip chute system 310 is open on the side facing the wheel 322. Otherwise, a stump grinding wheel 320 with stump cutting tooth assemblies 322 are shown with a guard device 313 (shown in a transparent view) positioned at least partially around the wheel, at least on a side that is opposite the wheel's cutting section. Positioned adjacent and proximally to the wheel 322 and guard section 313 is the chip chute system 310 (shown in a transparent view, and which can also be attached directly to the wheel 322 at or near the central axis or indirectly to the wheel by being attached to the guard section 313, which can be attached to the wheel at or near the central axis, or other location as should be understood by a person of skill in the art in conjunction with a review of this disclosure). This chip chute system 310 is open to capture cute chips at its proximal end 312, and is configured to form a seal etc. (as discussed with respect to other embodiments above). The distal end 316 has an opening at its most distal end for chips to exit. This embodiment of the chip chute system 310 can be adjustable at jointed or other sections like previously discussed embodiments, including at the flap or rotatable elements shown at the square-shaped distal end 316 of the chip chute system 310. Further, the chip chute system 310 can be connected to the frame of a “stand behind” or other machine at 314 that can maneuver the stump grinding wheel with the chip chute system 300, as should be understood by a person of skill in the art in conjunction with a review of this disclosure.

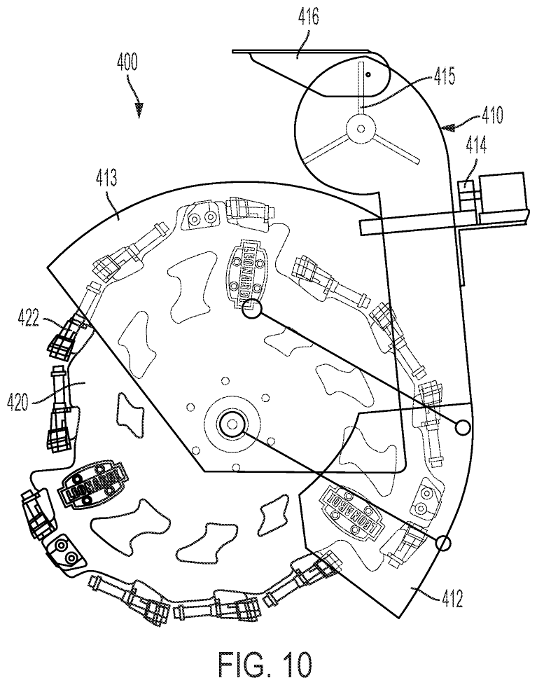

Referring to FIG. 10, a side schematic representation view of an alternative embodiment of the stump grinding wheel with a chip chute system 400 is shown. This embodiment is very similar to the embodiments shown and described with respect to FIGS. 8 and 9. The only major difference is the inclusion of a mechanism (mechanical and/or electromechanical, described generally above) such as a paddle wheel/wiper/booster 415 in the distal end 416 of the chip chute system 410 to assist with the movement of the chips out the distal end of the distal end 416 of the chip chute system 410. The chip chute system 410 can be open on the side facing the wheel 422 (like in FIG. 8), or can be closed at a position distally of the proximal end 412 to the distal end 416 (like in FIG. 9). Otherwise, a stump grinding wheel 420 with stump cutting tooth assemblies 422 are shown with a guard device 413 (shown in a transparent view) positioned at least partially around the wheel, at least on a side that is opposite the wheel's cutting section. Positioned adjacent and proximally to the wheel 422 and guard section 413 is the chip chute system 410 (shown in a transparent view, and which can also be attached directly to the wheel 422 at or near the central axis or indirectly to the wheel by being attached to the guard section 413, which can be attached to the wheel at or near the central axis, or other location as should be understood by a person of skill in the art in conjunction with a review of this disclosure). This chip chute system 410 is open to capture cute chips at its proximal end 412, and is configured to form a seal etc. (as discussed with respect to other embodiments above). The distal end 416 has an opening at its most distal end for chips to exit. This embodiment of the chip chute system 410 can be adjustable at jointed or other sections like previously discussed embodiments, including at the flap or rotatable elements shown at the distal end 416 of the chip chute system 410. Further, the chip chute system 410 can be connected to the frame of a “stand behind” or other machine at 414 that can maneuver the stump grinding wheel with the chip chute system 400, as should be understood by a person of skill in the art in conjunction with a review of this disclosure.

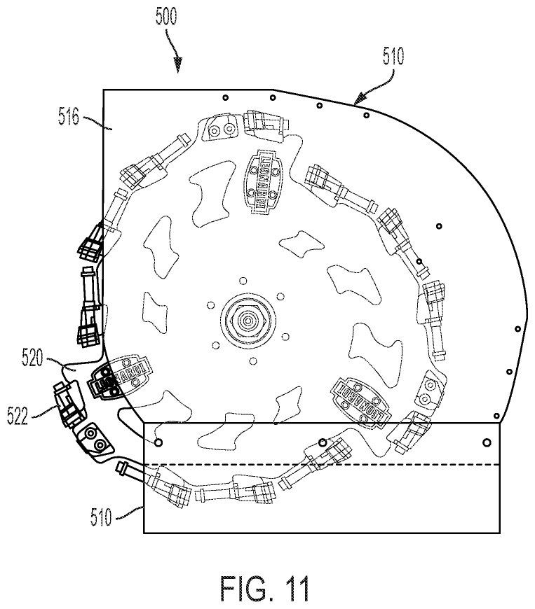

Turning to FIG. 11, a side schematic representation view of an alternative embodiment of the stump grinding wheel with a chip chute system 500 is shown. This embodiment shows a chip chute system 510 (shown in a transparent view) attached to the stump grinding wheel 520 at or near its central axis, and covering the majority of the stump grinding wheel 520 to improve the seal capability (with the proximal/bottom portion 512 enclosing the bottom portion of the wheel in rubber, metal, polymer, plastic or other material (as should be appreciated by those of skill in the art in conjunction with a review of this disclosure)) to enclose and seal the bottom portion of the wheel 520 in the proximal end 512 of the chip chute system 510 or seal the bottom portion of the wheel 520 to the ground (if the proximal end of the proximal end 512 of the chip chute system 510 is not fully enclosed) to capture and lead as many of the cut chips in the chip chute system 510 as possible. For example, as shown, the proximal end 512 of the chip chute system 510 is structured to be positioned adjacent to the cut, and the distal portion 516 is structured to be positioned almost directly above the proximal portion so that only ¼ to ⅓ of the wheel 520 is outside of the coverage of the chip chute system 510. This chip chute system 510 embodiment can be adjustable, as discussed with respect to previously discussed embodiments. Further, the chip chute system 510 can be connected to the frame of a “stand behind” or other machine that can maneuver the stump grinding wheel with the chip chute system 500, as should be understood by a person of skill in the art in conjunction with a review of this disclosure.

Turning to FIG. 12, a side schematic representation view of an alternative embodiment of the stump grinding wheel with a chip chute system 600 is shown. This embodiment shows the chip chute system 610 (shown in a transparent view) as part of the structure of frame of a “stand behind” or other machine 650 with wheels or moveable tread 652 that can maneuver the stump grinding wheel with the chip chute system 600. The chip chute system 610 can be part of a frame 626 that can be attached to the machine 650 at one or more connection points 628, 630. One or more of these connection points can be structured and configured to move the stump grinding wheel with a chip chute system 600 in any and all directions. As with other stump grinding wheel with a chip chute system embodiments discussed herein, the chip chute system 610 can include a proximal end 612 (which can form a seal etc.) and a distal end 616 where cut chips exit, where the distal end (and other portions of the chip chute system 610) can be adjustable. This particular embodiment shows the chip chute system 610 covering a majority of the wheel 620 and stump cutting tooth assemblies 622, but it does not have to. Additionally, a moveable section 620 is show, which is structured and configured to rotate at the central axis of the wheel 620 and move the proximal end 612 closer to or further away from the cut position “X.”

All definitions, as defined and used herein, should be understood to control over dictionary definitions, definitions in documents incorporated by reference, and/or ordinary meanings of the defined terms.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. An chip chute system, comprising:
an elongated chute positionable in spaced relation and at least partially around a stump grinding wheel and comprising a proximal portion and a distal portion defining a passageway positioned therethrough;
wherein at least one of the proximal portion and the distal portion is movable with respect to the other.

2. The chip chute system of claim 1, wherein at least one of the proximal portion and the distal portion is angularly pivotable with respect to the other.

3. The chip chute system of claim 1, wherein at least one of the proximal portion and the distal portion is at least partially slidable within the other.

4. The chip chute system of claim 1, wherein at least one of the proximal portion and the distal portion is rotatable with respect to the other.

5. The chip chute system of claim 1, further comprising a middle portion positioned between the proximal portion and the distal portion, wherein the middle portion is moveable with respect to at least one of the proximal portion and the distal portion or at least one of the proximal portion and the distal portion is moveable with respect to the middle portion.

6. The chip chute system of claim 5, wherein the middle portion is pivotable with respect to at least one of the proximal portion and the distal portion or at least one of the proximal portion and the distal portion is pivotable with respect to the middle portion.

7. The chip chute system of claim 5, wherein the middle portion is slidable within at least one of the proximal portion and the distal portion or at least one of the proximal portion and the distal portion is slidable within the middle portion.

8. The chip chute system of claim 5, wherein the middle portion is rotatable with respect to at least one of the proximal portion and the distal portion or at least one of the proximal portion and the distal portion is rotatable with respect to the middle portion.

9. A stump grinding wheel and chip chute system, comprising:
a stump grinding wheel with a central longitudinal axis positioned therethrough;
an elongated chute positioned in spaced relation and at least partially around a stump grinding wheel and comprising a proximal portion and a distal portion defining a passageway positioned therethrough;
wherein at least one of the proximal portion and the distal portion is movable with respect to the other.

10. The stump grinding wheel and chip chute system of claim 9, further comprising a stump cutting tooth assembly attached to a side or a perimeter portion of the stump grinding wheel.

11. The stump grinding wheel and chip chute system of claim 9, wherein at least one of the proximal portion and the distal portion is angularly pivotable with respect to the other.

12. The stump grinding wheel and chip chute system of claim 9, wherein at least one of the proximal portion and the distal portion is at least partially slidable within the other.

13. The stump grinding wheel and chip chute system of claim 9, wherein at least one of the proximal portion and the distal portion is rotatable with respect to the other.

14. The stump grinding wheel and chip chute system of claim 9, further comprising a middle portion positioned between the proximal portion and the distal portion, wherein the middle portion is moveable with respect to at least one of the proximal portion and the distal portion or at least one of the proximal portion and the distal portion is moveable with respect to the middle portion.

15. The stump grinding wheel and chip chute system of claim 14, wherein the middle portion is pivotable with respect to at least one of the proximal portion and the distal portion or at least one of the proximal portion and the distal portion is pivotable with respect to the middle portion.

16. The stump grinding wheel and chip chute system of claim 14, wherein the middle portion is slidable within at least one of the proximal portion and the distal portion or at least one of the proximal portion and the distal portion is slidable within the middle portion.

17. The stump grinding wheel and chip chute system of claim 14, wherein the middle portion is rotatable with respect to at least one of the proximal portion and the distal portion or at least one of the proximal portion and the distal portion is rotatable with respect to the middle portion.

18. The stump grinding wheel and chip chute system of claim 9, wherein a proximal end of the proximal portion has an opening with a cross sectional area larger than a cross sectional area of the passageway positioned distally to the opening.

19. The stump grinding wheel and chip chute system of claim 9, wherein a proximal end of the proximal portion is positioned below a midpoint plane of the stump grinding wheel.

20. The stump grinding wheel and chip chute system of claim 19, wherein a proximal end of the proximal portion is positioned at least ¾ of a radius of the stump grinding wheel below a midpoint plane of the stump grinding wheel.

21. The stump grinding wheel and chip chute system of claim 9, wherein the elongated chute is connected to the stump grinding wheel such that it can move with respect to the stump grinding wheel.

22. The stump grinding wheel and chip chute system of claim 21, wherein the elongated chute is connected to the stump grinding wheel via at least one bar such that the elongated chute can pivot at least partially around the stump grinding wheel.

23. The stump grinding wheel and chip chute system of claim 9, wherein a proximal end of the proximal portion has an opening positioned in a plane that is perpendicular to the travel of a wood chip when the system is in use.

24. The stump grinding wheel and chip chute system of claim 23, wherein the opening of the proximal portion is positioned between 0 inches and 5 inches from a chip exiting a cut by the stump grinding wheel when in use.

25. The stump grinding wheel and chip chute system of claim 10, wherein the at least one stump cutting tooth assembly comprises a tooth cutting length and is positioned within a distance as measured by the tooth cutting length from an interior surface of the elongated chute.

26. The stump grinding wheel and chip chute system of claim 9, wherein the positioning of the elongated chute around the stump grinding wheel is configured to create a boundary layer of cut material on an interior surface of the elongated chute to maintain at least some of the energy of the cut material imparted by the stump grinding wheel within the passageway.

27. The stump grinding wheel and chip chute system of claim 9, wherein a proximal end of the proximal portion includes a guard comprising at least one sided flap configured to catch and direct chips into the elongated chute.

28. The stump grinding wheel and chip chute system of claim 27, wherein the guard is flexible.

29. The stump grinding wheel and chip chute system of claim 28, wherein the guard is rigid.
